(19) United States
(12) Patent Application Publication
(10) Pub. No.: US 2007/0162639 A1
(43) Pub. Date: Jul. 12, 2007

(54) TCP-offload-engine based zero-copy sockets

(76) Inventors: Hsiao-Keng J. Chu, Palo Alto, CA (US); Nicolas Droux, San Jose, CA (US); Tao Ma, Sunnyvale, CA (US)

Correspondence Address: SUN MICROSYSTEMS INC.;C/O PARK, VAUGHAN & FLEMING LLP, 2820 FIFTH STREET, DAVIS, CA, 95618-7759, US

(21) Appl. No.: 11/291,553

(22) Filed: Nov. 30, 2005

(51) Int. Cl. G06F 13/28

(52) U.S. Cl. 710/22

(57) ABSTRACT

One embodiment of the present invention provides a system for sending data to a remote host using a socket. During operation the system receives a request from an application to write data to the socket, wherein the data is stored in a source memory buffer in user memory. Next, the system initiates a DMA (Direct Memory Access) transfer to transfer the data from the source memory buffer to a target memory buffer in a TCP (Transmission Control Protocol) Offload Engine. The system then returns control to the application without waiting for the TCP Offload Engine to send the data to the remote host.

### RELATED APPLICATION

The subject matter of this application is related to U.S. patent application Ser. No. 11/011,076, entitled, “SYSTEM AND METHOD FOR CONDUCTING DIRECT DATA PLACEMENT (DDP) USING A TOE (TCP OFFLOAD ENGINE) CAPABLE NETWORK INTERFACE CARD,” filed on 14 Dec. 2004 (Attorney Docket No. SUN1P784).

### FIELD OF THE INVENTION

The present invention relates to computer networking. More specifically, the present invention relates to a method and an apparatus for communicating data using a TCP (Transmission Control Protocol) Offload Engine based zero-copy socket.

### BACKGROUND

Related Art

The dramatic increase in networking speeds are causing processors to spend an ever increasing proportion of their time on networking tasks, leaving less time available for other work. High end computing architectures are evolving from SMP (Symmetric Multi-Processor) based designs to designs that connect a number of cheap servers with high speed communication links. Such distributed architectures typically require processors to spend a large amount of time processing data packets. Furthermore, emerging data storage solutions, multimedia applications, and network security applications are also causing processors to spend an ever-increasing amount of time on networking related tasks.

These bandwidth intensive applications typically use TCP (Transport Control Protocol) and IP (Internet Protocol) which are standard networking protocols used on the Internet, and the socket API (Application Programming Interface) which is a standard networking interface which is used to communicate over a TCP/IP network.

In order to efficiently utilize the bandwidth of a high speed link, TCP uses a sliding window protocol which sends data segments without waiting for the remote host to acknowledge previously sent data segments. This gives rise to two requirements. First, TCP needs to store the data until it receives an acknowledgement from the remote host. Second, the application must be allowed to fill new data in the memory buffer so that TCP can use the sliding window protocol to fill up the “pipe.” Note that the system can satisfy both of these requirements by copying data between the user memory and the kernel memory. Specifically, copying data between the user memory and the kernel memory allows the application to fill new data in the user memory buffer, while allowing the kernel (TCP) to keep a copy of the data in the kernel memory buffer until it receives an acknowledgement from the remote host.

Hence, in many systems, whenever data is written to (or read from) a socket, the system copies the data from user memory to kernel memory (or from kernel memory to user memory). Unfortunately, this copy operation can become a bottleneck at high data rates.

Note that, during a socket write or read operation, the system usually performs a DMA (Direct Memory Access) transfer to transfer the data between the system memory and a NIC (Network Interface Card). However, this data transfer is not counted as a “copy” because, (i) the DMA transfer has to be performed anyways, i.e., it has to be performed even if the data is not copied between the kernel memory and the user memory, and (ii) the DMA transfer does not burden the CPU.

The copy bottleneck can be eliminated by using a socket implementation that does not require data to be copied between the user memory and the kernel memory. Unfortunately, present approaches to implement such “zero-copy” sockets have significant drawbacks.

One approach is to use blocking sockets. When data is sent using a blocking socket, the socket call (e.g., socket write) blocks until an acknowledgement for the data is received from the remote system. Unfortunately, this approach can severely degrade TCP throughput, especially if it takes a long time for the acknowledgement to arrive (e.g., due to a long propagation delay).

Another approach is to use asynchronous sockets. In this approach, the socket write function call returns immediately, but the application must wait for a completion signal before filling the user memory buffer with new data. This approach requires changing application software to ensure that the application waits for a completion signal before filling new data in the memory buffer. Specifically, this approach requires changing the application software to use a “ring” of buffers instead of a single buffer in order to keep the network pipe full. Unfortunately, changing application software is often impossible, or prohibitively expensive.

Hence, what is needed is a method and an apparatus for communicating data using a socket without the above-described problems.

### SUMMARY

One embodiment of the present invention provides a system for sending data to a remote host using a socket. During operation the system receives a request from an application to write data to the socket, wherein the data is stored in a source memory buffer in user memory. Next, the system initiates a DMA (Direct Memory Access) transfer to transfer the data from the source memory buffer to a target memory buffer in a TCP (Transmission Control Protocol) Offload Engine. The system then returns control to the application without waiting for the TCP Offload Engine to send the data to the remote host.

In a variation on this embodiment, the system allows the application to fill new data in the source memory buffer immediately after the DMA transfer is completed.

In a variation on this embodiment, the application sends data to the remote host without requiring the system to copy the data from user memory to kernel memory.

In a variation on this embodiment, the system initiates the DMA transfer by programming a DMA controller by specifying the base address of the source memory buffer, the base address of the target memory buffer, and the amount of data to be transferred.

In a variation on this embodiment, the TCP Offload Engine stores the data until it is successfully sent to the remote host.

One embodiment of the present invention provides a system for receiving data from a remote host using a socket. During operation the system receives data from the remote host in a source memory buffer in a TCP (Transmission Control Protocol) Offload Engine. Next, the system receives a request from an application to read the data from the socket and to store the data in a target memory buffer in user memory. The system then initiates a DMA (Direct Memory Access) transfer to transfer the data from the source memory buffer in the TCP Offload Engine to the target memory buffer in user memory.

In a variation on this embodiment, the application specifies the target memory buffer after the TCP Offload Engine receives the data from the remote host.

In a variation on this embodiment, if the request to read the data is received prior to receiving the data from the remote host, the system programs the TCP Offload Engine to initiate the DMA transfer as soon as the data is received from the remote host.

In a variation on this embodiment, the application receives data from the remote host without requiring the system to copy the data from kernel memory to user memory.

### BRIEF DESCRIPTION OF THE FIGURES

FIG. 1 illustrates the layers of a networking stack for a system without a TCP Offload Engine in accordance with an embodiment of the present invention.

FIG. 2 illustrates the layers of a networking stack for a system with a TCP Offload Engine in accordance with an embodiment of the present invention.

FIG. 3 illustrates a system that uses a TOE to offload TCP-related computations from a processor in accordance with an embodiment of the present invention.

FIG. 4 presents a flowchart that illustrates a process for sending data to a remote host using a TOE-based zero-copy socket in accordance with an embodiment of the present invention.

FIG. 5 presents a flowchart that illustrates a process for receiving data from a remote host using a TOE-based zero-copy socket in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Networking Software Stack

Communication between two nodes of a network is typically accomplished using a layered software architecture, which is often referred to as a networking software stack or simply a networking stack.

Each layer in the networking stack is usually associated with a set of protocols which define the rules and conventions for processing packets in that layer. Each lower layer performs a service for the layer immediately above it to help with processing packets. Furthermore, each layer typically adds a header (control data) that allows peer layers to communicate with one another.

At the sender, this process of adding layer specific headers is usually performed at each layer as the payload moves from higher layers to lower layers. The receiving host generally performs the reverse of this process by processing headers of each layer as the payload moves from the lowest layer to the highest layer.

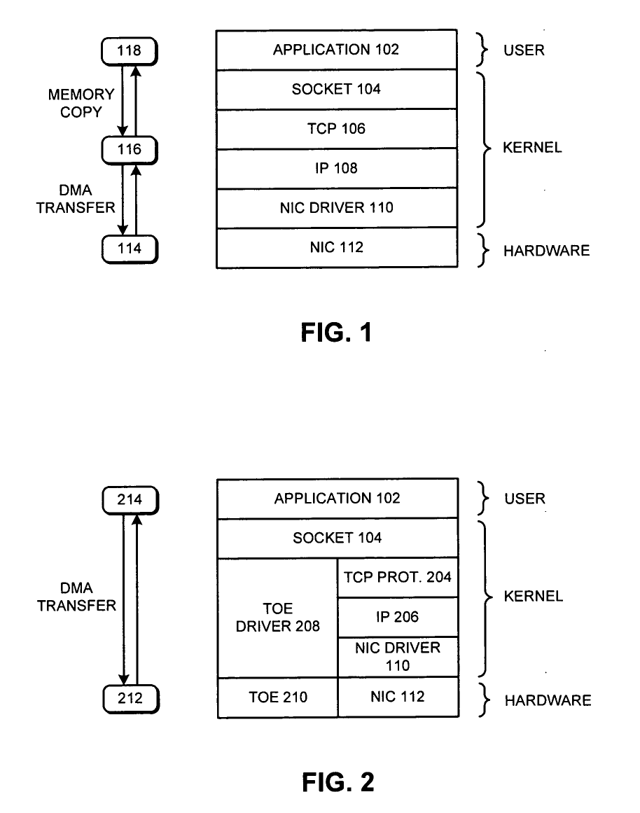

FIG. 1 illustrates the layers of a networking stack for a system without a TCP Offload Engine in accordance with an embodiment of the present invention.

Application layer 102 typically contains networking applications that communicate with other networking applications over a network. In a TCP/IP network, applications often communicate with one another using a socket layer 104 which provides a convenient abstraction for communicating with remote applications. The socket layer 104 usually employs a transport protocol, such as TCP 106, to communicate with its peers. TCP 106, in turn, uses IP 108 to send/receive packets to/from other nodes in the network. The IP 108 layer typically sends and receives data using a NIC 112 which is controlled by a NIC driver 110.

The application layer 102 typically includes application software that executes in user mode and uses memory buffers located in user memory. On the other hand, socket layer 104, TCP layer 106, IP layer 108, and the NIC driver 110 are part of the kernel which executes in protected mode and uses buffers located in kernel memory. Note that NIC 112 is a hardware component.

Sockets

In present systems, when an application reads data from a socket, it is copied from a buffer located in kernel memory to a buffer located in user memory. Conversely, when an application writes data to a socket, it is copied from a buffer located in user memory to a buffer located in kernel memory.

For example, while reading data from a socket, the data is first received in a memory buffer 114 located in the NIC 112. The data is then transferred using a DMA transfer from the NIC memory buffer 114 to memory buffer 116 which is located in kernel memory. Next, the data is copied from memory buffer 116 to memory buffer 118 which is located in user memory.

Similarly, while writing data to a socket, the data is copied from memory buffer 118 to memory buffer 116, and then transferred using a DMA transfer to buffer 114 located in the NIC 112. (Note that, for ease of discourse, we have illustrated the copy operation using the same buffers in both copy directions, but in an actual system they can be different buffers.)

Once the data is copied from user memory buffer 118 to kernel memory buffer 116, the application can fill new data into memory buffer 118. In other words, the copy semantics of a “socket write” function call are such that an application can start using the memory buffer as soon as the “socket write” call returns. Networking applications are written based on this copy semantic. Specifically, if we change the copy semantic, it can cause the networking application to malfunction. For example, suppose we change the socket implementation so that the “socket write” function does not copy the contents of the user memory buffer to a kernel memory buffer. In this case, the user application may overwrite data into the buffer while TCP is transmitting the data to the target system. Hence, copy semantics of socket calls must be preserved for proper operation of existing networking applications that use sockets. This is why eliminating the copy operation is a challenge.

Recall that, copying data between the user memory and the kernel memory is critical to efficiently utilize the bandwidth of a high speed link. Specifically, TCP typically uses a sliding window protocol which sends data segments without waiting for the remote host to acknowledge previously sent data segments. Copying data between the user memory and the kernel memory allows the application to fill new data in the user memory buffer, while allowing the kernel (and TCP) to keep a copy of the data until it receives an acknowledgement from the remote host.

Furthermore, recall that present techniques for eliminating the copy operation have severe drawbacks. In blocking sockets, the socket call (e.g., socket write) blocks until an acknowledgement for the data is received from the target system. Unfortunately TCP throughput may be severely degraded if it takes a long time for the acknowledgement to arrive.

In asynchronous sockets, the application must wait for a completion signal before filling the user memory buffer with new data. As a result, this approach requires changing application software to ensure that the application waits for a completion signal before filling new data in the memory buffer. Specifically, this approach requires changing the application software to use a “ring” of buffers instead of a single buffer in order to keep the network pipe full. Unfortunately, changing application software is often impossible, or prohibitively costly.

One embodiment of the present invention provides systems and techniques that can be used to implement zero-copy sockets without the above-described problems. Before we describe how embodiments of the present invention achieve this, we first describe TCP Offload Engines which play an important role in the present invention.

TCP Offload Engine (TOE)

TCP-related computations have traditionally been implemented in software because transport layer protocols, such as TCP, contain many complex computations that can be costly to implement in silicon. Furthermore, in the past, data rates have been low enough to justify performing TCP-related computations in software using a generic processor.

However, emerging networking applications and system architectures are causing the processor to spend an ever-increasing amount of time performing TCP-related computations. These developments have prompted system architects to propose TCP Offload engines that offload TCP-related computations from the processor.

FIG. 2 illustrates the layers of a networking stack for a system with a TCP Offload Engine in accordance with an embodiment of the present invention.

Note that interfacing a TOE with an OS usually does not require changes to the application layer 102 or the socket layer 104, which are shown in FIG. 2A exactly the same way as they were shown in FIG. 1. On the other hand, the TCP layer 106 and the IP layer 108 shown in FIG. 1 may need to be changed to offload TCP-related computation to the TOE.

TOE driver 208 allows the operating system to control the TOE 210. In one embodiment, the TOE/OS interface can include interfaces between the TOE driver 208 and other networking layers or software modules, such as the socket layer 104, the TCP 204 layer, the IP layer 206, and the NIC driver 110.

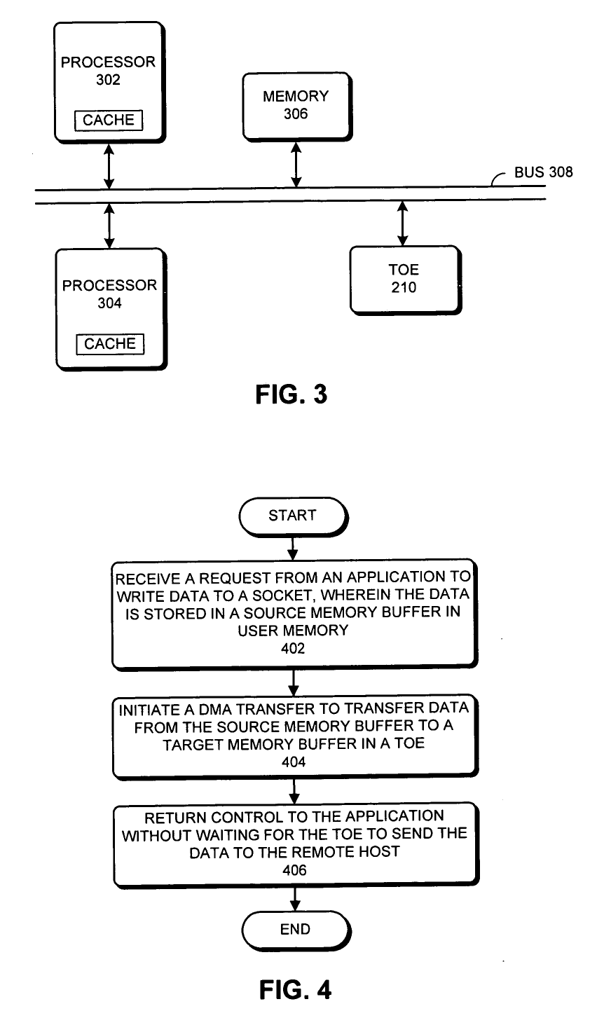

FIG. 3 illustrates a system that uses a TOE to offload TCP-related computations from a processor in accordance with an embodiment of the present invention.

The system illustrated in FIG. 3 comprises multiple processors 302 and 304 which can be part of an SMP. The system further comprises memory 306 and TOE 210. All of these components communicate with one another via the system bus 308.

In one embodiment, the user memory buffer resides in memory 306. Further, data can be transferred between TOE 210 and memory 306 using DMA transfers. (Note that the system shown in FIG. 3 is for illustration purposes only. Specifically, it will be apparent to one skilled in the art that the present invention is also applicable to other systems that have different architectures or that have different number of processors, memories, and TOEs.)

Process of Sending Data using a TOE-Based Zero-Copy Socket

FIG. 4 presents a flowchart that illustrates a process for sending data to a remote host using a TOE-based zero-copy socket in accordance with an embodiment of the present invention.

The process typically begins by receiving a request from an application to write data to the socket, wherein the data is stored in a source memory buffer in user memory (step 402).

The system then initiates a DMA (Direct Memory Access) transfer to transfer the data from the source memory buffer to a target memory buffer in a TOE (step 404).

Specifically, the DMA transfer can be initiated by programming a DMA controller by specifying the base address of the source memory buffer, the base address of the target memory buffer, and the amount of data to be transferred.

Next, the system returns control to the application without waiting for the TCP Offload Engine to send the data to the remote host (step 406).

The TCP Offload Engine usually stores the data until it is successfully sent to the remote host. Furthermore, note that the system typically allows the application to fill new data in the source memory buffer immediately after the DMA transfer is completed. Additionally, note that one embodiment of the present invention allows the application to send data to the remote host without requiring the computer to copy the data from user memory to kernel memory.

Recall that, in present systems, TCP processing is typically performed in the kernel, which is why the system copies the data from user memory to kernel memory. The kernel keeps the data in its buffers while it is sent to the remote host. Meanwhile, the application fills new data into the user memory buffers. In contrast, the present invention does not need to copy data between user memory and kernel memory because the TOE performs the TCP processing, and hence the kernel does not have to keep a copy of the data. Specifically, in one embodiment, the application can fill new data in the user memory buffer as soon as the system transfers the data from the user memory buffer to a memory buffer in the TOE.

Process of Receiving Data using a TOE-Based Zero-Copy Socket

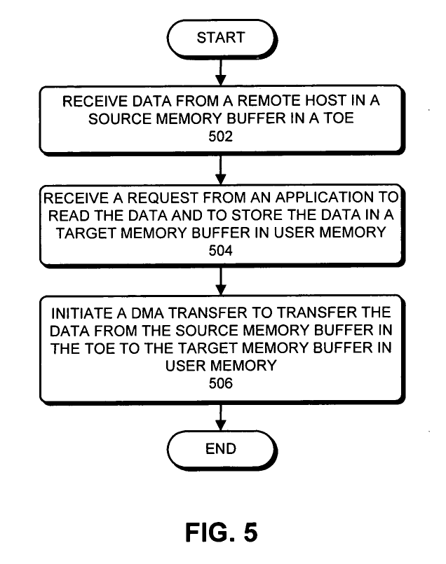

FIG. 5 presents a flowchart that illustrates a process for receiving data from a remote host using a TOE-based zero-copy socket in accordance with an embodiment of the present invention.

The process usually begins when the system receives data from the remote host in a source memory buffer in a TOE (step 502).

Next, the system receives a request from an application to read the data from the socket and to store the data in a target memory buffer in user memory (step 504).

Note that the application is not required to post the target memory buffer before the TCP Offload Engine receives the data from the remote host.

The system then initiates a DMA transfer to transfer the data from the source memory buffer in the TCP Offload Engine to the target memory buffer in user memory (step 506).

Note that, if the request to read the data is received prior to receiving the data from the remote host, the system can program the TOE to initiate the DMA transfer as soon as the data is received from the remote host.

Furthermore, note that one embodiment of the present invention allows the application to receive data from the remote host without requiring the computer to copy the data from kernel memory to user memory.

Note that, in asynchronous sockets, the application is required to specify memory buffers before the data is received from the remote host. In other words, in asynchronous sockets, the application has to pre-post memory buffers. In contrast, in the present invention, since the TOE can receive TCP data and store it in the TOE memory buffers, the application does not have to pre-post memory buffers. This aspect of the present invention is critical for ensuring that existing applications work with the present invention. Recall that asynchronous sockets require changes to existing applications to ensure that memory buffers are posted prior to executing a “socket read” function call. However, the present invention does not require any changes to existing networking applications because the TOE performs TCP processing and stores the data in its buffers till the application executes the “socket read” function.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-readable storage medium storing instructions that when executed by a computer cause the computer to perform a method for sending data to a remote host using a socket, the method comprising:
receiving a request from an application to write data to the socket, wherein the data is stored in a source memory buffer in user memory;
initiating a DMA (Direct Memory Access) transfer to transfer the data from the source memory buffer to a target memory buffer in a TCP (Transmission Control Protocol) Offload Engine; and
returning control to the application without waiting for the TCP Offload Engine to send the data to the remote host.

2. The computer-readable storage medium of claim 1, wherein the method allows the application to fill new data in the source memory buffer immediately after the DMA transfer is completed.

3. The computer-readable storage medium of claim 1, wherein the method allows the application to send data to the remote host without requiring the computer to copy the data from user memory to kernel memory.

4. The computer-readable storage medium of claim 1, wherein initiating the DMA transfer involves programming a DMA controller by specifying the base address of the source memory buffer, the base address of the target memory buffer, and the amount of data to be transferred.

5. The computer-readable storage medium of claim 1, wherein the TCP Offload Engine stores the data until it is successfully sent to the remote host.

6. A computer-readable storage medium storing instructions that when executed by a computer cause the computer to perform a method for receiving data from a remote host using a socket, the method comprising:
receiving data from the remote host in a source memory buffer in a TCP (Transmission Control Protocol) Offload Engine;
receiving a request from an application to read the data from the socket and to store the data in a target memory buffer in user memory; and
initiating a DMA (Direct Memory Access) transfer to transfer the data from the source memory buffer in the TCP Offload Engine to the target memory buffer in user memory.

7. The computer-readable storage medium of claim 6, wherein the application specifies the target memory buffer after the TCP Offload Engine receives the data from the remote host.

8. The computer-readable storage medium of claim 6, wherein if the request to read the data is received prior to receiving the data from the remote host, the method comprises programming the TCP Offload Engine to initiate the DMA transfer as soon as the data is received from the remote host.

9. The computer-readable storage medium of claim 6, wherein the method allows the application to receive data from the remote host without requiring the computer to copy the data from kernel memory to user memory.

10. The computer-readable storage medium of claim 6, wherein initiating the DMA transfer involves programming a DMA controller by specifying the base address of the source memory buffer, the base address of the target memory buffer, and the amount of data to be transferred.

11. An apparatus for sending data to a remote host using a socket, the apparatus comprising:
a receiving mechanism configured to receive a request from an application to write data to the socket, wherein the data is stored in a source memory buffer in user memory;
an initiating mechanism configured to initiate a DMA (Direct Memory Access) transfer to transfer the data from the source memory buffer to a target memory buffer in a TCP (Transmission Control Protocol) Offload Engine; and
a returning mechanism configured to return control to the application without waiting for the TCP Offload Engine to send the data to the remote host.

12. The apparatus of claim 11, wherein the apparatus allows the application to fill new data in the source memory buffer immediately after the DMA transfer is completed.

13. The apparatus of claim 11, wherein the apparatus allows the application to send data to the remote host without requiring the computer to copy the data from user memory to kernel memory.

14. The apparatus of claim 11, wherein the initiating mechanism is configured to program a DMA controller by specifying the base address of the source memory buffer, the base address of the target memory buffer, and the amount of data to be transferred.

15. The apparatus of claim 11, wherein the TCP Offload Engine stores the data until it is successfully sent to the remote host.

16. An apparatus for receiving data from a remote host using a socket, the apparatus comprising:
a data-receiving mechanism configured to receive data from the remote host in a source memory buffer in a TCP (Transmission Control Protocol) Offload Engine;
a request-receiving mechanism configured to receive a request from an application to read the data from the socket and to store the data in a target memory buffer in user memory; and
an initiating mechanism configured to initiate a DMA (Direct Memory Access) transfer to transfer the data from the source memory buffer in the TCP Offload Engine to the target memory buffer.

17. The apparatus of claim 16, wherein the application specifies the target memory buffer after the TCP Offload Engine receives the data from the remote host.

18. The apparatus of claim 16, wherein if the request to read the data is received prior to receiving the data from the remote host, the apparatus is configured to program the TCP Offload Engine to initiate the DMA transfer as soon as the data is received from the remote host.

19. The apparatus of claim 16, wherein the apparatus allows the application to receive data from the remote host without requiring the computer to copy the data from kernel memory to user memory.

20. The apparatus of claim 16, wherein the initiating mechanism is configured to program a DMA controller by specifying the base address of the source memory buffer, the base address of the target memory buffer, and the amount of data to be transferred.
